(19) United States
(12) Patent Application Publication
(10) Pub. No.: US 2009/0234684 A1
(43) Pub. Date: Sep. 17, 2009

(54) Risk Based Data Assessment

(76) Inventors: Mark Peter Stoke, Queensland (AU); Carl Ward, Australian Capital Territory (AU)

Correspondence Address: FISH & RICHARDSON P.C., P.O. BOX 1022, MINNEAPOLIS, MN, 55440-1022, US

(21) Appl. No.: 11/909,597

(22) PCT Filed: Mar. 24, 2006
(86) PCT No.: PCT/AU2006/000385

§ 371 Date: Jun. 23, 2008

(30) Foreign Application Priority Data
Mar. 24, 2005 (AU) 2005901484

(51) Int. Cl. G06Q 10/00; G06N 5/02; G06F 17/30; G06Q 50/00

(52) U.S. Cl. 705/7; 706/52; 707/200; 707/104.1; 707/E17.044

(57) ABSTRACT

A system for receiving and processing data includes a data processing and verification component that accepts data from a client in an electronic format and identifies therefrom data elements that can be directly verified. A risk assessment component receives data elements that have not been identified as directly verifiable and assesses a risk that the data elements are incomplete or incorrect. The risk assessment component generates risk assessment data. A decision support component receives the risk assessment data from the risk assessment component and selects appropriate actions for subsequent processing of the client data according to the assessment of risk contained in the risk assessment data.

### FIELD OF THE INVENTION

The present invention relates generally to a system and method of receiving data and conducting a risk assessment to determine future actions with respect to the data. The system and method of the present invention is particularly useful for receiving data from clients, conducting an assessment of the risk that the data is either incomplete or incorrect, and deciding future action as a result of the outcome of the assessment. The system and method of the present invention has application in any circumstances where data is collected from an individual or entity that cannot be trusted to provide complete and/or correct data.

### BACKGROUND OF THE INVENTION

With the advent of large data processing systems, significant efficiencies were achieved in receiving and processing data received from clients and automatically effecting actions on the basis of any received data.

Unfortunately, it is not always possible to trust that data received from clients is complete and/or correct thereby enabling subsequent processing and the effecting of appropriate actions. As a result, manual intervention is quite often required in instances where there is some concern that data is either incomplete and/or incorrect. This is particularly problematic for agencies that process requests that involve a financial outcome. For example, organisations such as the taxation department or insurance companies that process returns or claim applications are necessarily concerned that the data received from a client may be intentionally false in order for the client to obtain a financial benefit. Whilst there are systems presently in existence that quickly determine whether a client has failed to provide complete data, it is significantly more difficult to assess whether a client has provided incorrect data.

Whilst it has been known to apply metrics and/or rules to collected data in an attempt to locate substantial statistical variations from data received from individuals in a single classification with respect to one or more variables, in many cases the application of metrics and/or rules is relatively rudimentary and does not significantly reduce the amount of manual intervention that is presently required to address data received from clients that is either incomplete and/or incorrect. Of course, it is necessary to strike a balance between the level of risk that is acceptable with respect to automated processing of client data and the financial risk associated with over or under payment to a client. In the event that the risk assessment is not sufficiently accurate and incorrect/incomplete data is processed, then an agency such as a taxation department may incorrectly forward refunds to clients and/or fail to collect the appropriate amount of taxation revenue from their clients. On the other hand, if an automated data collection and processing system is not trusted to accurately assess data provided by clients, then the agency will suffer a significant overhead expense as a result of conducting a significant amount of manual intervention in order to reduce the risks associated with processing incorrect data.

Accordingly, there is a need to increase the accuracy of automated data collection and processing systems and methods such that the risk of processing incomplete and/or incorrect data is reduced as much as possible thus enabling agencies to reduce the overhead expense associated with manual intervention whilst at the same time reducing the risk of processing incorrect data to an acceptable level.

Any discussion of documents, devices, acts or knowledge in this specification is included to explain the context of the invention. It should not be taken as an admission that any of the material formed part of the prior art base or the common general knowledge in the relevant art on or before the priority date of the statements of invention and/or claims herein.

### SUMMARY OF THE INVENTION

In one aspect, the present invention provides a system for receiving and processing data including:

a data processing and verification component that accepts data from a client in an electronic format and identifies therefrom data elements that can be directly verified;

a risk assessment component that receives data elements that have not been identified as directly verifiable and assesses a risk that the data elements are incomplete or incorrect, the risk assessment component generating risk assessment data; and

a decision support component that receives the risk assessment data from the risk assessment component and selects appropriate actions for subsequent processing of the client data according to the assessment of risk contained in the risk assessment data.

Systems for receiving and processing data from clients typically cater for receiving client data in various forms. For example, clients may provide data to an agency by completion of a paper document and submitting same to the agency for subsequent processing. Alternatively, a client may prefer to provide data by contacting an operator within the agency by telephone and communicating the data in this manner. Similarly, many clients prefer to provide relevant data by a face to face meeting with an officer of the agency.

More recently, there have been significant efforts expended to encourage clients to provide relevant data in an electronic format and without the requirement for the involvement of an employee of the agency. In particular, many agencies have established web sites to enable their clients to obtain access by connection through the Internet. Typically, agencies will provide access to forms that request relevant data from clients that may be completed on-line and submitted directly to the agency subsequent to completion of the on-line form.

In any event, the system for receiving and processing data preferably caters for any form of data provided to the agency by a client, and irrespective of the form of the data received, the data is preferably translated into a consistent electronic format for subsequent processing.

In embodiments of the invention, data is collected from clients interactively as this enables different data to be collected from different clients depending upon their circumstances and their responses to specific requests for data. For example, if a client responds to a request for data relating to the type of insurance claim or taxation return he or she is proposing to file, the client will be presented with different requests based on the type indicated.

Having collected data from a client and translated same into a consistent electronic format for subsequent processing, the data processing and verification component processes collected client data to determine data elements that can be directly verified on the basis of the data itself. Some data elements are immediately and directly verifiable and in the event that data elements of this type are determined to be incomplete or incorrect, the system may immediately reject the data provided by the client and indicate the rejection to the client and request completion or correction before further processing of the data occurs. In embodiments where the collection of client data is an interactive process, data elements that are immediately determined to be incorrect or incomplete may be brought to the attention of the client for immediate completion and/or correction before the data is accepted for processing.

However, some data elements cannot be verified without the system accessing an external source of data to verify of those elements. It is these data elements that require a determination of risk with respect to the completeness and/or correctness of the data particularly where the external source of data is not available at the time that verification occurs.

In an embodiment, the risk assessment means includes risk models tailored to an individual client that are used to determine the risk of incomplete and/or incorrect data for that client. In this respect, tailoring a risk model to a particular client has been found to generate a significantly better assessment of risk as compared with the application of metrics and/or rules to groups of clients on the basis of one or more classifications of the client. In particular, an individually based risk model preferably includes a record of the past accuracy of interactions and the extent to which incorrect and/or incomplete data has been previously supplied by the client. Further, the individual client risk model may also include a history of other behaviour that can be identified as a result of any previous supply and/or verification of data from the client.

Further, the application of an individual client risk model may involve a comparison of data provided by the individual client as compared with data provided by other clients with similar circumstances. The individual risk model may also compare data provided by the client with an external data source containing data relating to the general state of the economy or other data sources containing information that is particularly relevant to the individual client circumstances such as data pertaining to criminal records, history of interactions with other agencies or information pertaining to any interactions involving client interaction with agencies in other countries.

In an embodiment, the individual client risk model includes separate components that relate to the different aspects of receiving and processing data provided by the client. For example, the risk model may include a separate component for assessing the risk of the client providing incomplete and/or incorrect data for particular types of interaction that are available for the client to interact with the agency. In some instances, clients may have a low level of risk for particular types of interaction yet exhibit high levels of risk for other types of interaction.

In any event, the risk assessment means conducts an assessment of the data provided by a client and determines the risk that any of the data is either incomplete or incorrect. The risk assessment means generates risk assessment data (which may be in the form of a risk profile) that quantifies the risk of incomplete or incorrect data and this risk assessment data is provided to the decision support means for a determination of the future action to be effected with respect to the client data. In an embodiment, the decision support means compares the risk assessment data from the risk assessment means with predetermined criteria that has been established by the agency that reflects a level of risk that the agency considers to be acceptable for the subsequent processing of client data. Comparison of the risk assessment data generated by the risk assessment means with the predetermined criteria reflecting an acceptable level of risk enables the decision support means to automatically continue the processing of client data that is considered to include an acceptable level of risk and to divert client requests containing data that is considered to include an unacceptable level of risk to an alternative process for further action by the agency.

Client data that is considered to include an unacceptable level of risk may be diverted to a process to resolve the unacceptable risk of incomplete and/or incorrect data. This process may involve manual intervention on the part of an operator employed by the agency.

In another aspect, the present invention provides a method of receiving and processing data collected from a client including the following steps:

interacting with a client in order to obtain data from the client pertaining to a particular client request;

analysing said collected data to identify those data elements that are directly verifiable from the collected data and further determining whether any of the elements of data that are directly verifiable are either incomplete or incorrect and repeating requests for any data elements that are determined to be incomplete and/or incorrect;

assessing the risk of any of the elements of data provided by the client that cannot be directly verified said assessment, quantifying the risk that any of the elements of data not directly verifiable are either incomplete or incorrect; and

determining the future action to be effected in relation to the client request taking into account the assessment of risk of incomplete or incorrect data and comparing same with a level of risk deemed acceptable to the agency for accepting and processing a client request.

In another aspect, the present invention provides a computer program embodied on a computer readable medium for receiving and processing data collected from a client, the computer program including:

computer instruction code for interacting with a client to collect data from the client pertaining to a particular client request;

computer instruction code for analysing said collected data and instruction code to identify those data elements that are directly verifiable;

computer instruction code for determining whether any of the elements of data that are directly verifiable are either incomplete or incorrect and causing repeat requests for any such data elements;

computer instruction code for assessing the risk of any of the elements of data provided by the client that cannot be directly verified said assessment quantifying the risk that any of the elements of data not directly verifiable are either incomplete or incorrect; and

computer instruction code for determining the future action to be effected in relation to the client request taking into account the assessment of risk of incomplete or incorrect data and comparing same with the level of risk deemed acceptable to the agency responsible for accepting and processing the client request.

The code may result in computer instructions that are implemented integrally to a computer or over a network using separate software components. The code may also include components of existing software that effect functions in cooperation with dedicated code developed specifically for the present invention.

In embodiments, the system, method and computer program for effecting the instant invention, are implemented to address the specific requirements of receiving taxation return data from clients and data relating to claims for insurance compensation. In any event, embodiments of the system, method and computer program of the present invention may be directed to address the specific requirements of any environment where data is collected from an individual or entity that cannot be trusted to provide complete and/or correct data.

### BRIEF DESCRIPTION OF THE DRAWINGS

An embodiment of the invention will now be described which should not be considered as limiting any of the statements in the previous section. This embodiment will be described with reference to the following figures in which:

FIG. 1 illustrates a typical lodgment process according to current arrangements (prior art);

FIG. 2 illustrates a lodgment process according to an embodiment of the present invention;

FIG. 3 is a schematic diagram of a system for processing data in accordance with an embodiment of the invention.

FIG. 4 shows a client risk profile example according to an embodiment of the invention.

FIG. 5 shows a system view for risk based processing according to an embodiment of the invention.

### DETAILED DESCRIPTION OF AN EMBODIMENT

An embodiment of the invention will now be described using the example of a government or statutory revenue agency, such as the taxation department, with respect to their processes for collecting client data and processing it as part of a taxation assessment lodgment. The word “lodgment” is used throughout this specification to describe the process of depositing or submitting data to an entity that requests such data. In some countries, this process is referred to as “filing” and these terms should be considered synonymous. In the following description, the term “lodgment” is used to describe the filing of a tax return by a tax payer. Initially, a typical prior art implementation is described in detail followed by a detailed description of an embodiment of the invention as applied to the process of assessing the risk of incomplete and/or incorrect data in a taxation return document.

### Prior Art Implementation of Taxation Assessment Processing

Taxation assessment processing is a process executed by a revenue agency in which a taxpayer lodges details of their personal income and expenses and wherein the revenue agency completes an evaluation of the client data provided. In the event that the agency accepts a client's lodgment, one or more financial transactions are made with respect to the taxpayer's account(s) or a request for funds from the taxpayer occurs.

The processing of taxation assessment lodgments incurs financial risk, because taxpayers may accidentally or deliberately provide information that is either incorrect or incomplete, resulting in a tax assessment for an incorrect amount, which can lead to the taxpayer receiving a refund for which they do not qualify, or receiving a request for funds by the agency that is incorrect. These outcomes can occur as certain types of data on the return form cannot be verified at the time the return is processed.

A tax return typically contains the following types of information:

identity information that uniquely identifies the taxpaying entity;

account information identifying the tax type(s), taxpayer account(s) and return period(s); and

financial information including details used to determine the assessment.

The financial information can be further subdivided into:

financial information that can be verified at the time the revenue agency processes the return (for example, an individual taxpayer may declare the salary they earned from an employer, and the employer may have previously provided that information to the tax agency); and

financial information that cannot be verified at the time the revenue agency processes the taxation assessment (for example, an individual taxpayer may declare the salary they earned from an employer, and the employer may not yet have provided that information to the tax agency or the client may claim deductions for which they are not required to provide receipts).

A tax return also typically contains the following additional types of information:

data pertaining to the client that may be collected by the agency for the purposes of gathering statistical information for tax modelling, audit selection or for other analytical purposes; and

totals or subtotals of figures on the lodgment form.

Certain elements of client data can be validated against the revenue agency's own records. For example, the revenue agency can validate Identity and Account Information against its taxpayer register and accounting system. Totals can be used to cross check the data forming the total. However, the category of information that represents the greatest risk to the revenue agency's task is the financial data that cannot be cross-checked.

The revenue agency is required to make an assessment whether to accept this data, request further supporting data or ask for corrections from the taxpayer.

Revenue agencies currently deal with the problem of processing financial information that cannot be cross-checked generally by either assigning an employee workforce to check each and every return manually or applying a series of checks with respect to the data to determine a course of action.

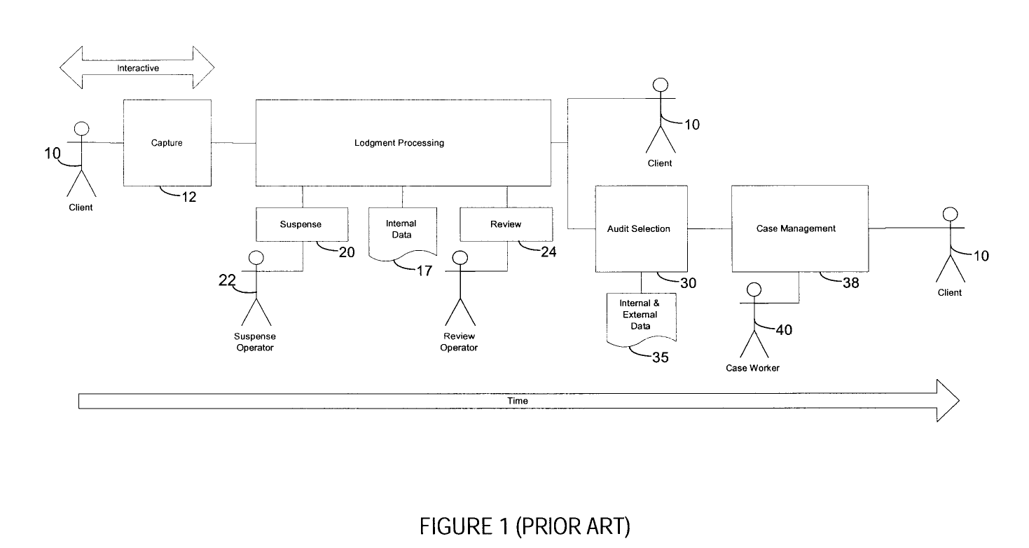

A diagrammatic representation of a typical tax return lodgment process as currently implemented is illustrated in FIG. 1. With reference to FIG. 1, the client 10 provides data to the lodgment processing system 15 through a capture process 12 that is preferably interactive. The lodgment processing system 15 attempts to detect data errors in the data captured from the client 10 and may use sources of internal data 17 in the process of attempting to detect errors. In the event that anomaly or error is detected in the data supplied by the client 10, the lodgment processing system 15 will direct the client's lodgment to either a suspense process 20 for consideration by suspense operator 22 or a review process 24 for consideration by a review operator 26.

In the event that there are no errors detected in the data supplied by the client 10, then the lodgment processing system 15 may process the lodgment and provide a tax return assessment to the client 10.

In the event that a client's tax return is chosen for an audit, the lodgment processing system 15 passes the client's return to the audit selection process 30 that typically makes use of internal and external data 35 during the process of conducting an audit of the client's tax return. In this instance, a case management process 38 is established and a case worker 40 is assigned to the audit task. Upon completion of the audit process, the client 10 is provided with a result and/or a completed tax return assessment.

A process typically implemented in current systems may use a combination of manual and/or automated checking as part of the process of identifying data that may be incomplete or incorrect in taxation return lodgments.

### Manual Checking

The typical process for manual checks begins with the distribution of paper copies of the returns to employees of the agency, referred to as assessors, who conduct the checks. The assessors are provided with guidelines or review criteria that outline the details they should check. The guidelines are a set of general rules applied to return forms filed by large groups of taxpayers. The assessor applies the guidelines to determine what course of action to take for each return. They may consult a supervisor or manager before a final decision is reached and this process can be characterised as depending to some degree on the personal judgement of an individual assessor.

### Automated Checking

The typical process for automated checking begins with the capture of data from return forms into a computer system. A set of general rules is programmed into the computer system that specifies conditions that will trigger follow-up action. These rules may include:
basic data validations that are designed to detect data capture errors or basic errors the taxpayer has made in completing the return form (for example, check that a date field contains a reasonable date or that sub totals and totals sum correctly);
inter field validations that are designed to detect unusual relationships between data fields on the return form (for example, there may be a rule for people categorised as professionals where the ratio between expenses claimed and income earned should be less than 3.75% such that professionals that claim a higher ratio may then be required to provide additional supporting information to justify their claim);
inter return period validations that are designed to detect unusual relationships between the same data fields on different return forms filed for the same taxpayer (for example, there may be a rule stipulating that if the income reported falls by more than 20% between two consecutive return periods the taxpayer would be required to provide additional supporting information);
comparison within peer groups in an attempt to detect returns that are statistical anomalies as compared with a group of similar taxpayers (for example, there may be a generally accepted range of incomes for professionals and in the event that an annual income is reported on a return that falls beneath that range, the tax payer may be required to provide additional information).

### Risk Based Data Assessment of a Taxation Return According to the Present Invention

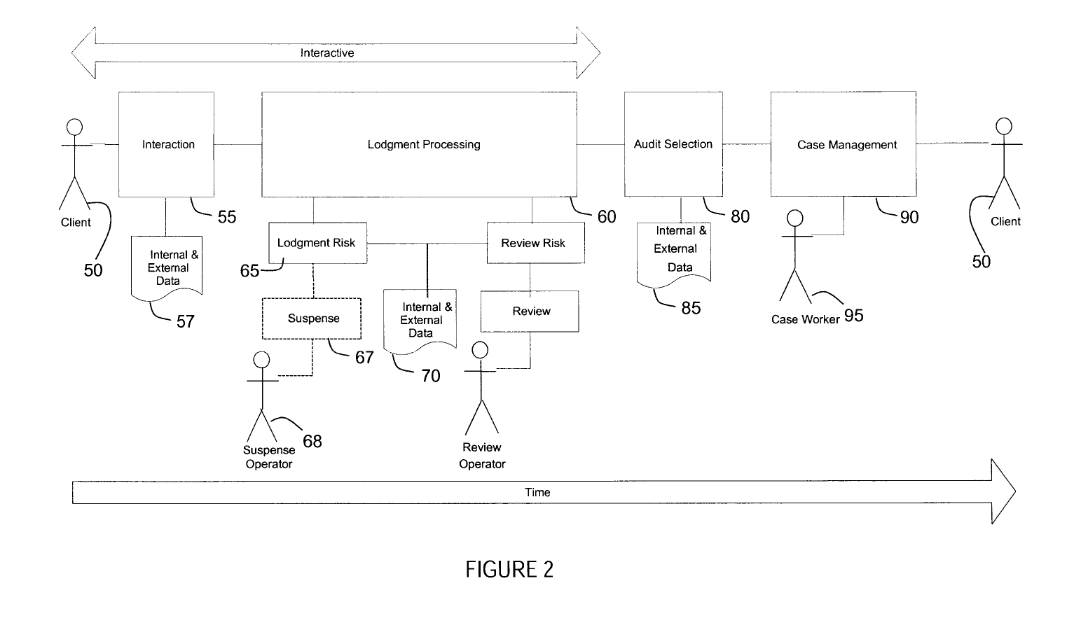

An embodiment of the invention is now described that relates specifically to the task of assessing the data contained in a client's tax return document. A diagrammatic representation of the process according to an embodiment of the invention is illustrated in FIG. 2.

With reference to FIG. 2, a client 50 provides data to a lodgment processing system 60 for processing their tax return document. The client 50 provides data to the lodgment processing system 60 through an interaction process 55 that uses internal and external data 57 as part of the process to provide an early detection of data that is incomplete and/or incorrect. During the process of considering the client's tax return document, the lodgment processing system 60 makes use of a lodgment risk analysis process 65. This process accesses and utilises internal and external data 70 in assessing the lodgment risk of the tax return document. In the event that a lodgment risk is detected, the client's tax return document is passed to a suspense process 67 and is subsequently considered by a suspense operator 68.

Internal and external data is used to develop an insight into the client risk profile and the expected characteristics of lodgments. Non-conforming lodgments are selected for audit and investigation as part of the audit selection process 80. The audit selection process 80 utilises internal and external data 85 as part of this process. Cases selected for audit are managed through a formal case management process 90 to investigate potential compliance problems. The case management process 90 is managed by a case worker 95. Upon completion of the processing of the client's tax return document, the client receives a tax return assessment.

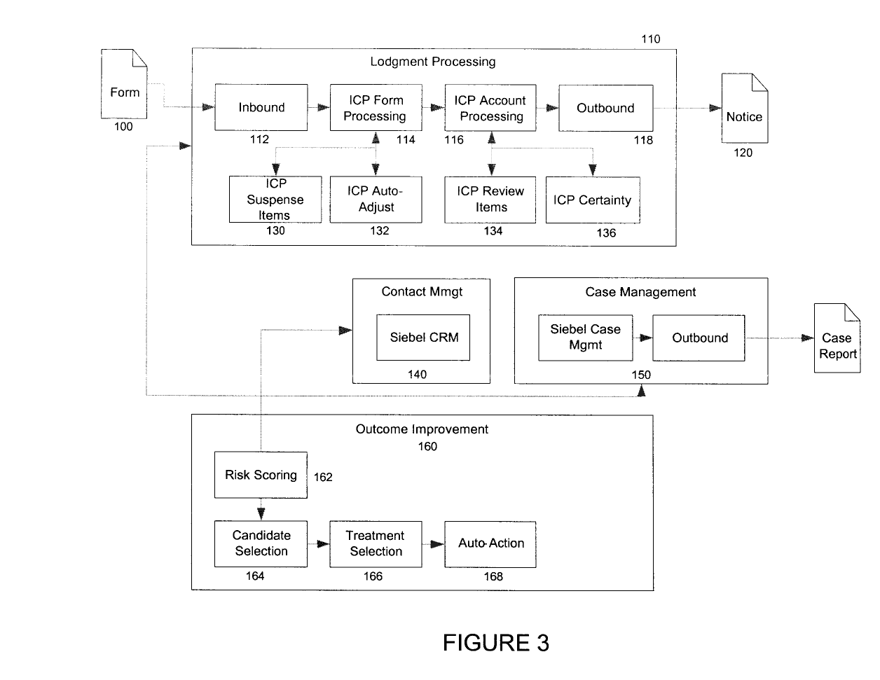

FIG. 3 is a schematic diagram of an example system which uses risk-based processing according to an embodiment of the invention. The example uses a tax administration system (referred to as ICP) and a customer relationship management (CRM) system. In the illustrated case the CRM is the Siebel CRM provided by Siebel Systems Inc., of California.

The diagram of FIG. 3 illustrates a tax return form 100 lodged by a client passing through a Lodgment Processing phase 110 and resulting in the issuance of an assessment notice 120. Lodgment Processing phase 110 is broken down into the steps Inbound 112, ICP Form Processing 114, ICP Account Processing 116 and Outbound 118. If discrepancies are identified during ICP Form Processing step 114, the lodgment is subjected to further processing through ICP Suspense Items 130 if manual intervention is required, or ICP Auto-Adjust 132 if a correction can be made automatically.

ICP Suspense Items 130 is a function that creates suspense work-items when the form data is incomplete. This operates in the same manner as prior art suspense processing. Suspense rules are specified in the form definition, with some additional rules in the form processing design. If a taxpayer is low risk and the error on the form is minor, the error is ignored and the form processed as-is.

ICP Auto-Adjust 132 is a new function not found in the prior art, that provides automated adjustment functionality for the lodgment transaction based on the risk profile. Auto-Adjust rules are specified in the form definition. When a form is filed late and subject to penalties and/or interest, automatically remit/reverse those charges if the filer is low risk. When a form contains minor errors, such as calculation errors, the figures are automatically adjusted (keeping an audit trail) and processing of the form is continued if the client is evaluated as a low risk client.

Two further steps which may occur during the lodgment processing phase 110 are ICP Review Items 134 and ICP Certainty 136. ICP Review Items is a function that creates review work-items when there is a credit balance posted (which may result in a refund) or the details of the form are considered suspicious. This operates in a similar manner to prior art methods of reviewing forms identified as potentially suspicious. Review rules are specified in a form definition for review items. The credit balance threshold is higher if a client is rated low risk than if the client is rated high risk. Similarly, the tolerance applied to suspicion thresholds is higher for low-risk clients.

ICP Certainty 136 is a new function not found in the prior art, that provides certainty to the taxpayer based on the risk profile for a particular period and assessment. Certainty rules are specified in a form definition for review items. If a client is low risk and the return is within norms the client is given certainty that they will not be audited.

FIG. 3 also includes a Contact Management module 140 and a Case Management module 150. These include standard contact management and case management functionality, but with the inclusion of risk profile information for each client. Thus if a client contacts an agency staff member requesting, for example, a change of address or bank account, the request may be escalated if the client's risk score makes this appropriate. During case management, a high risk client may, for example, be allocated to a more experienced case worker.

FIG. 3 also includes an Outcome Improvement module 160 which includes the steps of Risk Scoring 162, Candidate Selection 164, Treatment Selection 166 and Auto-Action 168. Risk Scoring 162 uses analytical models used to create a risk score for particular client behaviour. Risk scores and thresholds are aggregated into a risk profile for the client.

Candidate Selection 164 is a process for selecting candidates for further scrutiny from amongst the clients. Analytical models are used to select and prioritise a candidate list of clients fitting a certain risk of compliance (debt, lodgment, audit, discrepancy etc). Candidate Selection is enabled through three categories: Risk Scores (e.g. Post Issue Audit); Expert Rules (e.g. Campaigns); and Business Events (e.g. debt past due). Rules are defined through the analytical model.

Treatment Selection 166 uses treatment models used to select a particular treatment for a candidate based on the risk of compliance (letter, call, case etc). Treatments are defined through the analytical model and the treatment plan for a particular client. Risk scores are used to determine which action(s) to take in relation to the client. These actions could be alternative ways of serving the client or alternative ways of enforcing compliance.

### Applying Risk Based Processing to Return Forms

Applying a risk based approach to assessing the data on a return form should enable revenue agencies to make more informed and precise determinations as to where they should focus their efforts to generate a greater return on effort. In accordance with this approach, it is possible to allocate resources to tasks that provide an optimal delivery of revenue to the agency.

An embodiment of the invention continuously predicts compliance risk for each taxpayer and such a risk assessment may be used to intervene proactively with taxpayers to avoid lodgment of a non complying return.

In addition to providing a benefit to the agency, the risk based approach to processing tax returns also benefits the tax payer as it creates a regime in which it requires less effort for the tax payer to lodge a compliant return, which should have the effect of positively reinforcing desirable taxpayer behaviour.

In an embodiment of the invention, specialised personnel use actuarial skills and a broad range of data sources to conduct statistical analyses to produce a set of risk scores for each individual taxpayer. In some instances, a risk score may be used as a basis for intervening before a taxpayer effectively lodges a non compliant return. Tax payers determined to represent a low risk may not be required to provide as much information as compared with taxpayers determined to represent a high risk.

It is preferable to embed risk assessment in the return processing as much as possible rather than treating this aspect as a follow up activity later in time. This effectively means that audit selection criteria may be applied in the course of processing a tax return.

The risk scores generated and applied to each individual taxpayer may be used to determine the claims for which the revenue agency will analyse the return form upon actual lodgment. The processing rules should vary according to the risk score with high risk cases having more checks applied throughout the process whilst low risk cases will generally proceed with fewer checks.

In the instance of tax payers lodging returns using an interactive channel (eg the Internet, interactive voice response systems etc) the risks scores may be applied at each major step in the interaction and the outcomes of that check may change the course of the interaction. Preferably risk scores for each taxpayer are kept up to date using information captured in the course of processing a tax return. Further, the risk approach can be applied to offer preferential treatment to clients with normally “good” behaviour. For example, whilst it is currently the practice to apply a penalty to a client who lodges a late return, in the instance that this were the first time and the client has a history of good behaviour before the taxation department and the lateness is not undue, then the penalty may be remitted.

Further, the risk based approach may be applied to personalise any online interaction such that it would be possible to force high risk clients or clients in a particular segment or category to provide additional data that others are generally not required to provide. The effect of this aspect of the approach would be to capture data that could result in a lower overall risk score than would otherwise be the case and again, preferential treatment may be afforded to clients who are willing to provide the additional data that will most likely lead to a lower overall risk score.

The risk based approach according to the present invention should constrain the number of items that require investigation and hence focus the agency on those items for investigation that should result in the best return on effort.

### Client Risk Profiles

A client risk profile is a group of attributes that provides risk based information about the client. Attribute types include:

Risk Model Scores, which rate the likelihood of the client behaving in a particular way in relation to a specific risk (e.g. the likelihood of a client paying a debt within 14 days of the due date).

Operational Thresholds (constraints), which provide personalised information related to specific attributes of the client's transactions that support the Tax Office processing systems making automated assessments.

Both of these attribute types may be determined on specific client behaviour, or influenced by a segment within which the client operates (e.g. industry code). A risk profile will exist for each registered client; if an entity registers with different relationships, the risk profile may be influenced by the multiple relationships.

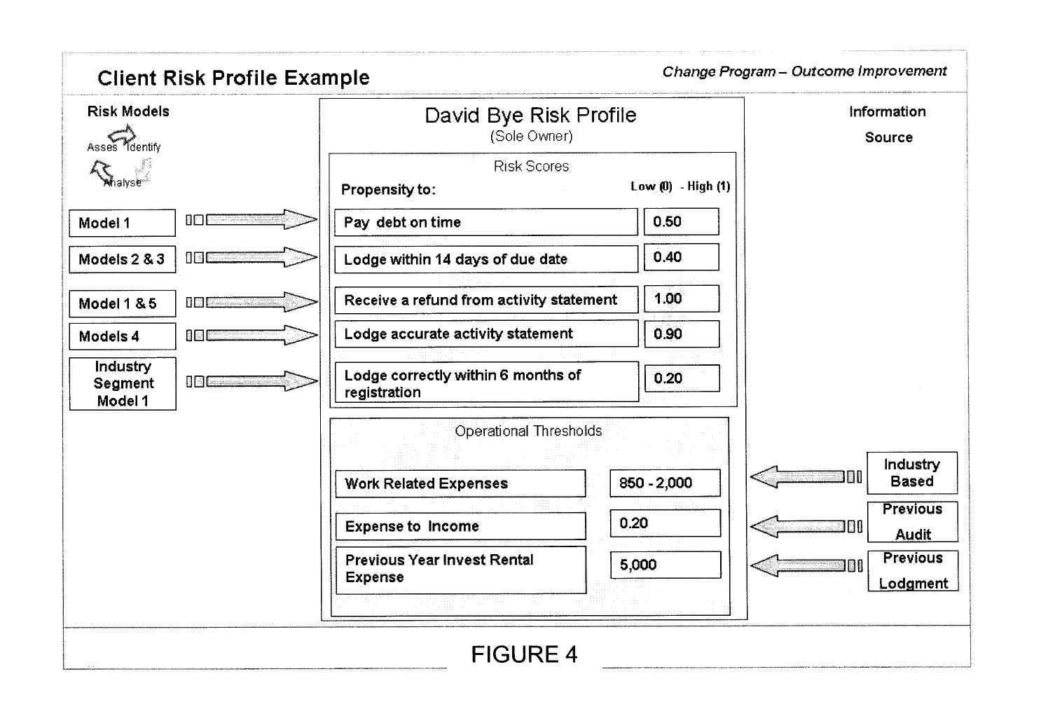

FIG. 4 shows an example of a Client Risk Profile. In this example, risk scores are assigned to the client for the client's propensity to:

Pay debt on time;

Lodge within 14 days of due date;

Receive a refund from activity statement;

Lodge an accurate activity statement; and

Lodge correctly within 6 months of registration.

The Client Risk Profile of FIG. 4 also includes Operational Thresholds for the following items:

Work related expenses;

Expense to income ratio; and

Previous year investment rental expense.

### Design and Development of Risk Scores

The design and development of risk scores involves the development of a risk model that codifies the relationship between the revenue agency's data holding and the probability of certain events occurring in the future.

To complete this activity it is preferable for the revenue agency to have a precise definition of what the agency considers to be a risk and the relevant tolerance to risk (i.e. thresholds). Further, it is preferable that the agency develop a taxpayer register and tax payer accounting system containing detailed historical records covering the most recent five years or more.

Access to data on general trends in the economy (for example from a government agency responsible for statistics) is also preferred along with the establishment of formal agreements with other government agencies to supply taxpayer specific data that can then be incorporated into a risk model. Again, a continuous supply of risk data from other government agencies is preferred with at least data covering the most recent five years being provided in the first instance.

Formal agreements with commercial third parties to supply taxpayer specific data may also be established for incorporation of that data into a risk model. Other infrastructure assets would also be preferred in an embodiment of the invention including a data warehouse holding data from the various available sources and structured to support data analysis. In this respect, a complete and up to date dictionary that holds the metadata for the data held in a data warehouse and commercial data analysis software capable of supporting actuarial analysis would be particularly preferred.

### Designing Tax Payer Risk Types

In an embodiment of the invention a data schema for at least the following risk types are established:
a composite predictive risk score calculated from the set of risk types;
assessment of risk that the taxpayer will accidentally misreport income;
assessment of risk that the taxpayer will accidentally misreport expenses or deductions;
assessment of risk that the taxpayer will deliberately misreport income;
assessment of risk that the taxpayer will deliberately misreport expenses or deductions;
assessment of risk that the taxpayer will lodge a late return (with a score for each tax type);
assessment of the risk that the taxpayer will not pay the full amount due by the relevant due date.

The preferred implementation for the predictive risk score schema includes predictive risk scores for a taxpayer stored in a computer system such that it is possible to add new categories of predictive risk scores without requiring programming changes. Further, it is preferable that all scores follow the same schema so they can be evaluated and manipulated in a consistent manner.

Scores are preferably in the form of a probability with the ability to distinguish a minimum of 100 distinct levels of risk. For example, a zero level of risk means that there is no chance of the event occurring and a 100 level of risk means that the event will definitely occur. The scores may be displayed as a percentage probability such that they could be used directly in a statement such as “there is a 63% probability that the taxpayer will misreport expenses or reductions”. Of course, a larger number of distinct levels of risk may be provided which would then allow a higher level of precision in the reporting of probabilities.

Preferably, there is a time stamp for each predictive risk score indicating when that risk was last updated. Further, it is preferable that each predictive risk score have an associated reason code indicating the event that triggered the last update. A history of predictive risk scores may be maintained to make it possible to analyse whether risk is increasing or decreasing with regard to any particular tax payer over time. This history should disregard changes that only occur as a result of changes to the risk model as its purpose would be to reflect changes arising from the individual taxpayer's behaviour and circumstances.

### Scoring Procedure

Scoring procedure is preferably defined for each risk type that specifies how the score will be calculated. The scoring procedure should identify the data in the data dictionary used to calculate the score and the specific algorithms or functions of the risk model that will be applied to the data.

### Development of Peer Groups

When revenue agencies place taxpayers in segments they typically define a small set of large groups and assign the taxpayer to one of those groups. However, a risk based assessment of return documents in accordance with the instant invention requires a more refined approach to segmenting tax payers.

The purpose of this step is to define a large schema of taxpayer groups and assign the taxpayer to multiple groups. This is intended to improve the fidelity of any risk analysis. Peer groups form a collection of overlapping hierarchical schema and an example of an initial sample peer group schema extended to three levels would be:

Entity
Natural person
   Gender
   Age Group
   Employment status
   Dependents
   Ranges of Gross Income
Non-natural person
   Legal Form (Corporation etc)
   Industrial Classification
   Ultimate owner's location
   Ranges of Gross Income

Location
Urban
   City 1
   City 2
   . . .
Rural
   Region 1
   Region 2
   . . .

Natural Activity
Industrial classification (Sub groups of manufacturing, retail etc.)

In one embodiment, the preferred implementation for the peer group schema involves giving each peer group a unique identity and a textual description of what it represents. Taxpayers are assigned to none, or one or more peer groups, and when a taxpayer is assigned to a peer group, a time stamp is recorded for the event. When a taxpayer is removed from the peer group, another time stamp is preferably recorded for this particular event as well. Preferably, a history will be maintained of the peer groups that the taxpayer has belonged to in the past.

### Relationship Between Peer Groups and Risk Types

Once peer groups have been defined, the relationship between peer groups and risk types is defined. This relationship is used to determine which risk types to calculate for any particular tax payer.

The relationship may be defined as a matrix (referred to hereinafter as the “peer group to risk type matrix”) that collates peer groups with the risk types. For example, a partial matrix is presented below as Table 1.

TABLE 1

| | | Risk the Taxpayer will | |
|---|---|---|---|
| Risk | Risk the Taxpayer | accidentally | |
| Type | will accidentally | misreport Expenses | |
| Peer Group | misreport Income | or Deductions | . . . |
| Corporation | Include | Include | . . . |
| Private Company | Include | Include | . . . |
| . . . | . . . | . . . | . . . |

### Analysis of Peer Group Characteristics

This particular step in the process generates a set of statistical characteristics for each peer group that support aspects of the risk scoring process. These characteristics can be divided into:
general features that can be populated with meaningful data regardless of the specific peer group being characterised (for example, measuring percentiles of gross income);
peer group specific features for information that is only meaningful in relation to a sub set of peer groups (for example, the percentiles of high technology research tax incentives).

Each peer group is preferably characterised and this information used to derive the characteristics of intersections of peer groups. For example, the percentiles of income from employees working in a particular city in the banking services sector. Peer group characteristics are preferably re-analysed periodically and not less frequently than monthly. In some instances, some peer group characteristics may be reanalysed as frequently as daily.

### Development of Initial Risk Model

Once prerequisites have been satisfied, the first step in this process is to develop a risk model. This is preferably an automated process that predicts the probability a taxpayer will be non compliant based on the data available at the time the prediction is to be made.

Various types of information would be considered in this risk model and whilst the following risk list is not exhaustive, it illustrates the types of data that should be considered for inclusion:
broad trends in the economy (eg cost of living indices, manufacturing production indices etc);
statistics for the various peer groups the tax payer is considered to belong to which may include other tax paying entities that earn income in the same way (eg sole proprietors operating a retail business, employees working in manufacturing etc), other tax paying entities with similar tax affairs (eg employees who own residential rental properties) and other tax paying entities in the same general location (eg CBD of a particular city or a real location etc).
changes in tax legislation (eg a change to the list of legitimate deductions of a type the taxpayer has previously claimed);
tax payer specific risk analyses from third parties (eg credit rating agencies);
the past behaviour of the taxpayer in varied situations in relation to the revenue agency which may include, timeliness of past lodgments of tax returns, timeliness of past payments (including behaviour in relation to past payment arrangements), history of reassessments, audit results and the nature of formal advice provided by the agency to the tax payer (eg if there has been advice provided about the treatment of a certain type of expense reported through the tax return).

The purpose of the risk model in the context of this embodiment of the invention is to assess the risk that data provided by a taxpayer on a tax return form is incorrect by using the information available at the time when the return is processed.

The risk model in this embodiment of the invention is developed on the basis of analysing correlations between information that would be known at the time a return form is processed as compared with historical cases of non-compliance. Strong correlations are incorporated into the risk model and weighted according to their effect at predicting non-compliance with respect to historical data. These correlations may be discovered by hypotheses driven experimentation and/or by training a neural network. The predictive capabilities of a risk model according to this embodiment of the invention may be improved over time as new information is gathered.

Further, the risk model should be continuously improved as more information becomes available from external sources and/or the processing of interactions with taxpayers.

### Development of Interaction Types and Risk Responses

Risk will be typically assessed in the course of many types of interactions and, for each of these interactions, the revenue agency will need to determine how it should respond to each risk type at each level of risk.

The first step in considering this process is to specify each type of interaction that would be analysed and subject to a risk based processing approach. In an embodiment of the invention, this takes the form of a table such as Table 2 below.

TABLE 2

| Interaction Category | Interaction Type | Interaction Characteristic |
|---|---|---|
| Return Filing | Individual Income | Interactive Channel |
| | Tax Return Filing | |
| Return Filing | Individual Income | Non-Interactive Channel |
| | Tax Return Filing | |
| Return Filing | Sole proprietor | Interactive Channel |
| | Income Tax Return | |
| | Filing | |
| . . . | . . . | |

Further, each risk type should be mapped to one or more interactions that can occur between the individual tax payer and the revenue agency thus producing a “risk type to interaction matrix”. This matrix can be consulted to determine which risk types should be considered in determining the risk involved in a particular interaction with a particular taxpayer.

In an embodiment of the invention, a partial matrix is used as represented in Table 3 below.

TABLE 3

| | | | Predictive | Interaction | |
|---|---|---|---|---|---|
| Interaction | Characteristic | Risk Type | Risk | Risk | Response |
| Return | Interactive | Risk the | High | . . . | . . . |
| Processing | Channel | Taxpayer | Medium | Very high | Allow taxpayer to |
| Business | | will accidentally | | | complete entry |
| Income Tax. | | misreport | | | and then route the |
| Gross Income | | Income | | | form to manual |
| Component | | | | | review |
| | | | | High | Require the tax |
| | | | | | payer to provide |
| | | | | | supporting detail |
| | | | | Medium | Prompt the |
| | | | | | taxpayer with |
| | | | | | additional |
| | | | | | questions |
| | | | | Low | Process without |
| | | | | | review |
| | | | Low | . . . | . . . |
| . . . | . . . | . . . | . . . | . . . | . . . |

### Applying a Risk Model to a Taxpayer

A further step in this process is to apply the risk model to each taxpaying entity. There are two major aspects of this step of the process including assignment of the taxpayer to peer groups and subsequently applying the risk model to produce the predictive risk score for each taxpayer.

In an embodiment of the invention, taxpayers are assigned to peer groups by an automated process that applies the criteria defining each peer group to the taxpayer. Taxpayers are assigned into all relevant peer groups in the schema based on the registration information that the tax agency holds and based on past tax return information. For example, a taxpayer may be an individual working in the retail sector in a particular city with no dependents and earning a particular gross income. The outcome of this activity is a peer group membership listing that records the peer groups to which the taxpayer belongs.

### Applying the Risk Model to Produce the Predictive Risk Scores for Individual Taxpayers

In an embodiment of the invention, this activity populates the predictive risk scores for each taxpayer by applying all relevant scores and procedures in the risk model. The major aspects of this step of the process include:
reference to the peer group membership for the taxpayer and the peer group to risk type matrix to determine which risk types to score; and
for each risk type, determine which data is required by the risk model to produce the predictive risk score, obtain the data and apply the algorithms in the risk model and record the predictive risk score against each taxpayer.

Specific predictive risk scores for a taxpayer are preferably revised whenever the underlying risk model is updated and when new information is gathered in the course of an interaction with the taxpayer.

### Procedure for Evaluating Risk During Return Processing

The predictive risk scores provide an initial view of risk in relation to each taxpayer. This information may be used to set a strategy for the return processing interaction. In the course of the return processing interaction, new information will be provided by the taxpayer on the tax return document and this information should also be incorporated into the treatment of risk during return processing.

### Process for Applying the Taxpayer Risk Model to Return Processing

In an embodiment of the invention, a return form is comprised of a collection of fields into which taxpayers are required to enter information. This includes amongst other things, labels that identify the fields and instructions that assist the taxpayer to complete the fields correctly. Items in this collection are referred to as “components” in this embodiment of the invention.

Typically, there are only a relatively small number of variations to the standard return form for any particular return period. With the application of risk based data assessment, the components presented to a taxpayer may be selected based upon the established risk for a particular client. For example, if a taxpayer is considered likely to mis-state their income, they may be presented with several components requiring them to provide information relating to specific details of the respective sources of their income.

Where a taxpayer is presented with a return form to complete, the components of the return form may be selected for each individual taxpayer based on the taxpayer's individual predictive risk scores. In the case of a paper based return, there is an option to personalise some parts of the return form.

As the revenue agency processes each return form it may calculate interaction risk scores. In this embodiment of the invention, these are calculated using the same risk model that is used for calculating predictive risk scores but differs in that the interaction risk scores make use of the information gathered in the course of processing the return form.

Interaction risk scores are designed to manage instances where a taxpayer who is rated as a low risk in a predictive risk score provides information that represents a high risk. The interaction risk scores may detect this risk and provide an opportunity to implement an appropriate response.

Interaction risk scores may be calculated several times in the course of processing a single return as the taxpayer provides further new information. Interaction risk scores are preferably stored in a computer system with respective interaction risk scores associated with the various interaction types that are provided.

The interaction risk scores are preferably used to determine what action to take by interrogating the risk response matrix. Where risk response conflicts arise (for example, if a risk response for one risk type indicates the return should be processed without further analysis and another risk response indicates that the return should be transferred for manual revenue) a hierarchy of risk responses should be applied. The most thorough risk response to the most severe risk should determine the result for the entire interaction.

### Variants to Risk Based Return Processing

With respect to an embodiment of the invention, return processing may be considered to fall into one of two categories:
interactive (where the taxpayer enters the information using a service channel that enables the revenue agency to participate directly in the flow of the process); or
non interactive (where the taxpayer enters the information using a service channel that does not enable the revenue agency to participate directly in the flow of the process).

An obvious example of a non interactive return processing is a paper return form.

For interactive return processing, the overall risk represented by the return form may be calculated at the time the taxpayer, or their representative, enters the data and the result may be used to direct the course of the interaction. If the interaction risk score is high, the taxpayer is likely to be provided with additional guidance to assist them to complete the return correctly and they are likely to be required to enter additional information.

With respect to non interactive risk based return processing, there are fewer effective means for directing the course of the interaction at the time the data is entered. However, the interaction can be designed at the time the return form is generated for the taxpayer.

In this respect, the choice of form the taxpayer is requested to complete may be based upon the individual taxpayer's predictive risk score related to the relevant type of return processing. In this instance, the return form may instruct the taxpayer to complete additional forms or schedules depending upon the information they enter. These instructions may be personalised to the taxpayer in accordance with their predictive risk score.

Risk based processing for non interactive forms of return processing are implemented based on the predictive risk score calculated for an individual taxpayer. The risk of the interaction may be determined at a later time subsequent to capture of the return data by the revenue agency and any follow up actions may occur later.

### Risk Based Processing System View

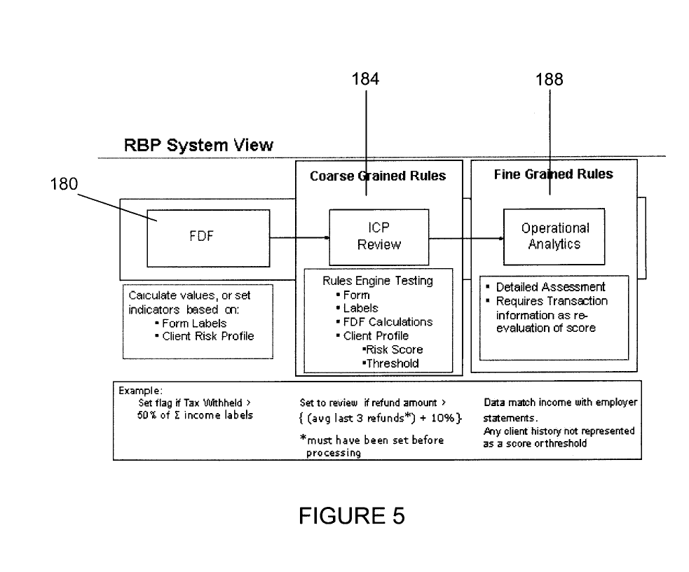

FIG. 5 shows a system view for risk based processing according to an embodiment of the invention. The system view shows a forms definition component FDF 180, a coarse-grained rules component 184 which incorporates the tax administration system (ICP) review, and a fine-grained rules component 188 which incorporates operational analytics.

“Operational Analytics” enables past behaviour, either of a specific client or based on a client segment, to be captured and used to populate the client risk profile. The risk profile contains both risk scores and operational thresholds.

FDF enables business users to define rules and calculations based on information provided in the form being processed. From a risk perspective many prior art risk assessments are based on information contained within the form. Utilising FDF's ability to define rules will enable the tax agency to set hidden fields within the form that provide an indication if a risk condition has been reached. The existence of the risk condition or combinations of conditions can be tested within ICP review rules.

Risk rules preferably remain confidential and can only be maintained by a limited number of staff members. Additionally the risk rules should not be exposed in any external interface where the generic FDF form validation rules are being exposed.

ICP Review rules enable rules based on a greater selection of taxpayer and account attributes and risk profiles. The ICP review rules and engine will preferably support:
Rules based on label values within a form.
Test conditions can be applied to literals, and Taxpayer Risk Profile values.
Test conditions can be applied to derived fields from FDF calculations

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A system for receiving and processing data including:
a data processing and verification component that accepts data from a client in an electronic format and identifies therefrom data elements that can be directly verified;
a risk assessment component that receives data elements that have not been identified as directly verifiable and assesses a risk that the data elements are incomplete or incorrect, the risk assessment component generating risk assessment data; and
a decision support component that receives the risk assessment data from the risk assessment component and selects appropriate actions for subsequent processing of the client data according to the assessment of risk contained in the risk assessment data.

2. A system for receiving and processing data according to claim 1 wherein the risk assessment component applies a risk model to the client based on one or more of:
a record of past accuracy of interactions with the client;
the extent to which incorrect and/or incomplete data has been previously supplied by the client;
a history of other behaviour that can be identified as a result of any previous supply and/or verification of data from the client.

3. A system for receiving and processing data according to claim 1 wherein the risk assessment component applies a risk model to the client based on one or more of:
a comparison of data provided by the individual client with data provided by other clients with similar circumstances;
a comparison of data provided by the client with an external data source containing general statistical information;
data sources containing information that is particularly relevant to the individual client circumstances such as data pertaining to criminal records, history of interactions with other agencies or information pertaining to any interactions involving client interaction with agencies in other countries.

4. A system for receiving and processing data according to claim 1 wherein the risk assessment component applies a client-specific risk profile to data submitted by the client, wherein the client-specific risk profile includes risk scores assessing the client's propensity to undertake certain behaviours.

5. A system for receiving and processing data according to claim 4 wherein the client-specific risk profile includes operational thresholds which indicate expected ranges of values for items in the data submitted by the client, the expected ranges being based upon previous data submitted by the client, industry based statistical averages, or information available from other sources.

6. A system for receiving and processing data according to claim 1 wherein the data processing and verification component includes an autoadjustment component which automatically corrects data submitted by the client which has been identified as verifiable but incorrect.

7. A system for receiving and processing data according to claim 1 wherein the decision support component includes a certainty component which issues a notification that no further processing will occur if data submitted by the client has been verified as correct and the risk assessment component assesses a risk for the client which is lower than a predetermined threshold.

8. A system for receiving and processing data according to claim 1 wherein the data processing and verification component includes an interactive component which automatically provides feedback to the client in respect of data submitted by the client which has been identified as verifiable but incorrect.

9. A method of receiving and processing data collected from a client including the following steps:
interacting with a client in order to obtain data from the client pertaining to a particular client action;
analysing the collected data to identify data elements that are directly verifiable from the collected data, further determining whether any of the elements of data that are directly verifiable are either incomplete or incorrect, and repeating requests for any data elements that are determined to be incomplete and/or incorrect;
assessing a risk associated with any of the elements of data provided by the client not identified as directly verifiable, said assessment quantifying the risk that any of the elements of data not identified as directly verifiable are either incomplete or incorrect; and
determining future action to be effected in relation to the client request taking into account the assessment of risk of incomplete or incorrect data and comparing same with a level of risk deemed acceptable for accepting and processing a client request.

10. A method according to claim 9 wherein the risk assessment step involves applying a risk model to the client based on one or more of:
a record of past accuracy of interactions with the client;
the extent to which incorrect and/or incomplete data has been previously supplied by the client;
a history of other behaviour that can be identified as a result of any previous supply and/or verification of data from the client.

11. A method according to claim 9 wherein the risk assessment step involves applying a risk model to the client based on one or more of:
a comparison of data provided by the individual client with data provided by other clients with similar circumstances;
a comparison of data provided by the client with an external data source containing general statistical information;
data sources containing information that is particularly relevant to the individual client circumstances such as data pertaining to criminal records, history of interactions with other agencies or information pertaining to any interactions involving client interaction with agencies in other countries.

12. A method according to claim 9 wherein the risk assessment step involves applying a client-specific risk profile to data submitted by the client, wherein the client-specific risk profile includes risk scores assessing the client's propensity to undertake certain behaviours.

13. A method according to claim 12 wherein the client-specific risk profile includes operational thresholds which indicate expected ranges of values for items in the data submitted by the client, the expected ranges being based upon previous data submitted by the client, industry based statistical averages, or information available from other sources.

14. A method according to claim 9 wherein the data analysis step includes autoadjustment to automatically correct data submitted by the client which has been identified as verifiable but incorrect.

15. A method according to claim 9 wherein the step of determining future action includes issuing a notification that no further processing will occur if data submitted by the client has been verified as correct and the risk assessment component assesses a risk for the client which is lower than a predetermined threshold.

16. A method of processing data received from a client including the following steps:
analysing the collected data to identify data elements that are directly verifiable from the collected data;
determining whether any of the elements of data that are directly verifiable are either incomplete or incorrect;
determining whether any of the elements of data identified as incomplete or incorrect are suitable for autocorrection, and if so, automatically correcting those elements;
obtaining a risk profile for the client based on the data collected from the client and on any additional information available concerning the client;
applying the risk profile to the data collected from the client to determine whether further processing should be undertaken in respect of any of the elements of data provided by the client not identified as directly verifiable; and
applying further processing to the data collected from the client if directly verifiable data has been identified as incomplete or incorrect but not autocorrectable, or if the step of applying the risk profile has resulted in an indication that further processing is required.

17. A method according to claim 16 wherein the risk profile includes data derived from one or more of:
a record of past accuracy of interactions with the client;
the extent to which incorrect and/or incomplete data has been previously supplied by the client;
a history of other behaviour that can be identified as a result of any previous supply and/or verification of data from the client.

18. A method according to claim 16 wherein the risk profile includes data derived from one or more of:
a comparison of data provided by the individual client with data provided by other clients with similar circumstances;
a comparison of data provided by the client with an external data source containing general statistical information;
data sources containing information that is particularly relevant to the individual client circumstances such as data pertaining to criminal records, history of interactions with other agencies or information pertaining to any interactions involving client interaction with agencies in other countries.

19. A method according to claim 16 wherein the risk profile includes risk scores assessing the client's propensity to undertake certain behaviours.

20. A method according to claim 19 wherein the risk profile includes operational thresholds which indicate expected ranges of values for items in the data submitted by the client, the expected ranges being based upon previous data submitted by the client, industry based statistical averages, or information available from other sources.

21. A computer program embodied on a computer readable medium for receiving and processing data collected from a client, the computer program including:
computer instruction code for analysing data collected from the client and instruction code to identify data elements that are directly verifiable;
computer instruction code for determining whether any of the elements of data that are directly verifiable are either incomplete or incorrect;
computer instruction code for assessing a risk associated with any of the elements of data provided by the client that have not been identified as directly verifiable, said assessment quantifying the risk that any of the elements of data not identified as directly verifiable are either incomplete or incorrect; and
computer instruction code for determining the future action to be effected in relation to the client request taking into account the assessment of risk of incomplete or incorrect data and comparing same with a predetermined acceptable level of risk.

22. A computer program embodied on a computer readable medium according to claim 21 further including computer instruction code for interacting with a client to collect data from the client pertaining to a particular client action.

23. A computer program embodied on a computer readable medium according to claim 22 further including computer instruction code for causing repeat requests for any data elements identified as being directly verifiable but either incomplete or incorrect.

24. A computer program embodied on a computer readable medium according to claim 21 wherein the computer instruction code for assessing a risk includes a client-specific risk profile which provides risk scores assessing the client's propensity to undertake certain behaviours.

25. A computer program embodied on a computer readable medium according to claim 21 wherein the client-specific risk profile includes operational thresholds which indicate expected ranges of values for items in the data submitted by the client, the expected ranges being based upon previous data submitted by the client, industry based statistical averages, or information available from other sources.

26. A method of processing data received from a client including the following steps:
analysing the collected data to identify data elements that are directly verifiable from the collected data;
determining whether any of the elements of data that are directly verifiable are either incomplete or incorrect;
determining whether any of the elements of data identified as incomplete or incorrect are suitable for autocorrection, and if so, automatically correcting those elements;
obtaining a risk profile for the client based on the data collected from the client and on any additional information available concerning the client, wherein the risk profile includes risk scores assessing the client's propensity to undertake certain behaviours and operational thresholds which indicate expected ranges of values for items in the data submitted by the client, the expected ranges being based upon previous data submitted by the client, industry based statistical averages, or information available from other sources;
applying the risk profile to the data collected from the client to determine a level of risk of errors or omissions in the data collected from the client, and to determine whether further processing should be undertaken in respect of any of the elements of data provided by the client not identified as directly verifiable; and
applying further processing to the data collected from the client if directly verifiable data has been identified as incomplete or incorrect but not autocorrectable, or if the step of applying the risk profile has resulted in an indication that further processing is required.
